(19) United States
(12) Patent Application Publication
(10) Pub. No.: US 2016/0329155 A1
(43) Pub. Date: Nov. 10, 2016

(54) BEADING TOOL, HOUSING PART FOR AN ELECTROCHEMICAL CELL, AND METHOD FOR TREATING A HOUSING PART

(71) Applicant: EPCOS AG, München (DE)

(72) Inventor: Norbert Will, Heidenheim (DE)

(73) Assignee: Epcos AG, Munchen (DE)

(21) Appl. No.: 15/110,863

(22) PCT Filed: Jan. 5, 2015
(86) PCT No.: PCT/EP2015/050052

§ 371 Date: Jul. 11, 2016

(30) Foreign Application Priority Data
Jan. 13, 2014 (DE) 10 2014 100 302.0

(51) Int. Cl. H01G 9/08; H01G 9/145; B21D 15/00; H01G 9/045; H01G 13/00; B21D 13/00; H01G 9/00; H01G 9/048

(52) U.S. Cl. CPC H01G 9/08; H01G 9/0029; H01G 9/145; H01G 9/048; H01G 9/045; H01G 13/006; B21D 13/00; B21D 15/00

(57) ABSTRACT

A beading tool (1) for the beading of a workpiece (10) is provided, the beading tool (1) having a contact area (2), which is designed to interact with the workpiece (10), the contact area (2) having a multiplicity of local elevations (4) that are delimited from one another. Also provided is a housing part (10) for an electrochemical cell (100), which defines a cavity and has at least one indentation (6), a multiplicity of local depressions (5) being formed in the indentation (6).

The present application concerns a beading tool for the beading of a workpiece, a housing part for an electrochemical cell, an electrochemical cell and a method for treating a housing part.

A bead in conjunction with an electrochemical cell is described for example in DE 10332093 and U.S. Pat. No. 7,495,889 B2.

An object to be achieved is that of providing an improved beading tool, an improved housing part for an electrochemical cell and also means for treating and/or producing an improved housing part and/or an electrochemical cell.

This object is achieved by the features of the independent patent claims. Advantageous configurations and developments are the subject of the dependent patent claims.

A proposed beading tool is provided for the beading of a workpiece. The beading tool has a contact area, which is designed to interact with the workpiece, the contact area having a multiplicity of local elevations that are delimited from one another. The contact area is preferably designed in such a way that, during said interaction or beading of the workpiece, it forms or defines an indentation or bead, that is to say a channel-shaped depression, in the workpiece. The workpiece is for example a housing or a housing part of an electrochemical cell. The tool is expediently formed from a deformable material, for example a metal.

The elevations are preferably formed and arranged in such a way as to form during the beading of the workpiece depressions therein, for example in said bead, that largely correspond in form and size to the elevations of the contact area of the beading tool.

The distance of a first elevation of the contact area from an elevation that is arranged closest to it differs from the distance of a second elevation from an elevation that is arranged closest to it. The elevations of the contact area may be at different distances from one another. In this way it can be made possible that a bead is produced irregularly in the workpiece. In particular, the beading tool may be suitable for producing a multiplicity of depressions that are directed in different directions. As a result, the material of the workpiece can be deformed in such a way that information concerning the original form is lost, so that an elastic recovery after the ending of the deformation by the beading tool only occurs to a small extent. The distance between two elevations may be interpreted here as meaning the distance between the respective midpoints of the elevations.

Beads serve in a housing part, for example of an electrochemical cell, such as an electrolytic capacitor, preferably for the radial bracing, for example of a capacitor winding in relation to the housing or housing part.

With the aid of the bead, the capacitor winding can preferably be held or braced from a number of sides, for example axially and radially.

A further aspect of the present invention concerns a housing part for an electrochemical cell, for example a housing. The housing part defines a cavity and has at least one indentation, a multiplicity of local depressions being formed in the indentation. The indentation is preferably a bead.

The housing part has preferably been beaded or treated by means of the beading tool, as described above.

The housing part is preferably cup-shaped, with a side that is open and a side that is closed for example by a cover.

The beading tool can be used for example during production or treatment of the housing part to form the latter advantageously with the indentation and the multiplicity of local depressions. The local depressions are preferably delimited from one another.

In particular during the production or assembly of an electrochemical cell, for example of an electrolytic capacitor, the local depressions in the indentation of the housing part allow a housing part to be connected to an electrode stack or fixed in relation to it in such a way that the electrochemical cell can withstand particularly high vibrational loading and/or impact loading without being damaged. Specifically, the provision of the local depressions allows a relative movement of the electrode stack in the axial direction in relation to the housing part to be prevented particularly efficiently, so that internal electrical contact interruptions or instances of damage in the electrochemical cell, in particular in the case of automotive applications of the electrochemical cell, can likewise be prevented.

In a preferred configuration of the housing part, the indentation extends over the entire circumference of the housing part. By this configuration, a relative movement, preferably an axial relative movement, of the aforementioned electrode stack in relation to the housing part (or vice versa) can be prevented particularly advantageously.

In a preferred configuration of the housing part, the indentation is not an upset bead. For an explanation of the term “upset bead”, reference is made to DE 10332093.

In a preferred configuration of the beading tool, one dimension of the elevations is less than a width of the contact area. By this configuration, a surface of the aforementioned bead or indentation can be made particularly large, for example in comparison with an indentation with a smooth surface and without the elevations according to the invention. The multiplicity of local depressions delimited from one another in the indentation of the housing part advantageously allow deformations of the housing part, for example during the beading of the housing part, to be formed in the smallest possible space, whereby outer dimensions of the housing part, for example a length of the housing part, are not influenced or increased, or only very little. Furthermore, after the beading of the housing part or workpiece, a recovery, for example of a wall of the housing part, when the beading tool is removed can be prevented.

The depressions according to the invention in the indentation of the housing part also advantageously allow the forming of a bead with which a plastic material deformation or material displacement preferably does not take place toward the periphery of the bead but largely also within the bead itself, so that a thinning of the bead, in particular at the periphery of the bead, is partially counteracted. In this way, advantageously less influence is brought to bear on outer dimensions, for example the length, of the housing part.

In a preferred configuration of the beading tool, the elevations have elevation areas with an area content of between 0.1 mm² and 1 mm². Each elevation preferably has an elevation area with an area content of between 0.1 mm² and 1 mm².

In a preferred configuration of the beading tool, the distance between adjacent elevations is greater than 0.5 mm.

In a preferred configuration of the beading tool, the elevations are arranged in a randomly distributed and/or irregular manner. This configuration allows the beading of the workpiece to be advantageously performed particularly expediently, it being possible in particular to prevent a regular deformation (“gearwheel coupling”) of the housing part or of the respective workpiece by the beading tool during the interaction between the beading tool and the housing part.

In a preferred configuration of the beading tool, the individual elevations have different diameters and/or dimensions.

In an advantageous configuration of the beading tool, the beading tool is a beading wheel or a beading roller. This configuration makes particularly expedient beading or treatment of the housing part or workpiece possible, so that in particular the indentation or bead can be formed over the entire circumference of the housing part (see above).

The beading tool may be designed to interact with the workpiece unilaterally from the outside. Unilaterally may mean in this connection that the beading tool only acts on the workpiece from one side, without a counter element to the beading tool acting on the workpiece from the opposite side. The directional designation “from the outside” may mean in this context that the beading tool acts on the workpiece from an outer side. For example, the workpiece may define a principal axis, the beading tool acting on the workpiece in a direction that is directed toward the principal axis. The workpiece may define a cavity, the beading tool acting on the workpiece in a direction that is directed toward the cavity.

In particular in the case of a unilateral deformation of a workpiece, there may be a recovery and elastic deformations after the actual deformation of the workpiece by the beading tool. If, on the other hand, an indentation is formed by a beading wheel and a corresponding counter wheel, the elastic component of the deformation is much less.

The use of the beading tool described above with a multiplicity of local elevations that are delimited from one another at different distances from one another can make it possible to achieve a unilateral deformation of a workpiece with a small elastic component. In this way, it can be made possible for example to perform the forming of the depression in an electrochemical cell only after the introduction of the electrode stack.

In a preferred configuration of the housing part, it has a principal axis, the indentation being a first indentation, and the housing part having a second indentation, which is arranged axially offset from the first indentation. The second indentation is preferably of the same kind as the first indentation.

Two axially offset indentations usually make the axial fixing of the housing part in relation to a housed electrode stack more difficult. In particular, the formation of the second bead in a conventional beading process can have the effect that the bracing that originates from the first bead is loosened by the second.

This problem can be solved in particular by the beading according to the invention, the indentation of the housing part having a multiplicity of local depressions, in conjunction with the last-mentioned embodiment.

A further aspect of the present application concerns an electrochemical cell comprising the housing part, an electrode stack being arranged or accommodated in the housing part, and the at least one indentation fixing the electrode stack in relation to the housing part.

In a preferred configuration of the electrochemical cell, it is formed according to an electrolytic capacitor, the electrode stack being a capacitor winding, which comprises electrode films and an electrolyte that is in contact with the electrode films.

In a preferred configuration of the electrochemical cell, the electrolytic capacitor is an aluminum electrolytic capacitor with an anode of aluminum or mainly comprising aluminum.

A further aspect of the present invention concerns a method for treating a housing part. The method comprises providing a housing part and a beading tool and providing the housing part with a bead by means of the beading tool in such a way that a multiplicity of local depressions that are delimited from one another are formed in the bead. The method allows the housing part to be formed expediently with the multiplicity of local depressions, so that the aforementioned advantages for the housing part and/or the electrochemical cell can be used.

The depressions of the housing part are preferably brought about by the elevations of the beading tool.

In a preferred configuration of the method, when providing the housing with the bead in a first working step by means of a coarse beading tool, a contour of the bead and/or of the depressions is stamped into the housing part.

In a preferred configuration of the method, when providing the housing with the bead in a subsequent working step by means of a fine beading tool, the depressions are defined.

The expression “contour” of the bead preferably relates to a bead that just has contours of the depressions, these contours being defined by said subsequent working step with the fine beading tool, according to their desired ultimate form.

Alternatively, the expression “contour” may relate to a smooth surface of the bead.

In a preferred configuration of the method, the method is a method for producing an electrochemical cell, wherein an electrode stack is provided and introduced into the housing part before providing the housing part with the bead, the electrode stack being fixed in the housing part by being provided with the bead.

In a preferred configuration of the method, after introducing the electrode stack into the housing part, the latter is first deformed until the housing part touches the electrode stack, the housing part subsequently being provided with the bead.

The beading or treating of the housing part makes it necessary for there expediently to also be a corresponding device, in which for example a beading wheel or beading tool is accommodated and in which the latter is fixed in relation to the housing part and/or the electrochemical cell.

Before the treatment of the housing part or before the housing part is provided with the bead according to the invention or the indentation including the multiplicity of local depressions, the housing part may in a prior method step first be pre-beaded with a conventional bead, for example comprising a smooth bead area without depressions. Subsequently, said housing part may be provided according to the invention with the bead, including the multiplicity of local depressions.

When producing the bead, the beading tool may act on the housing part unilaterally from the outside.

Preferably, the electrochemical cell described above is treated, can be treated or can be produced by means of the method described here. In particular, all of the features disclosed for the method may also relate to the electrochemical cell, the beading tool and/or the housing part, and vice versa.

Further advantages, advantageous configurations and expedient aspects of the invention emerge from the following description of the exemplary embodiments in conjunction with the figures.

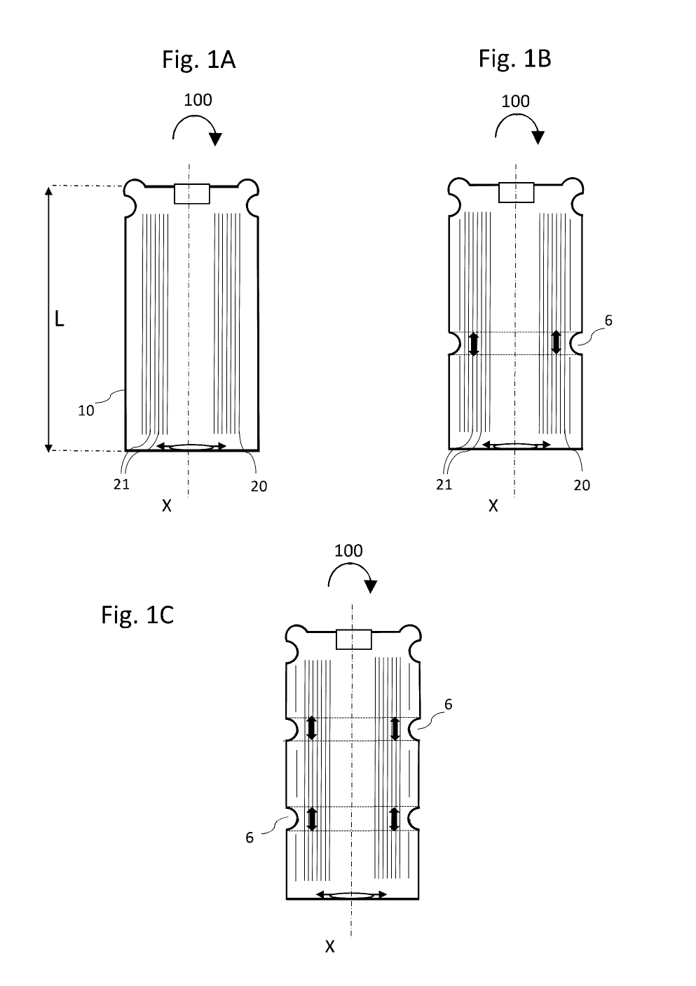

FIGS. 1A, 1B and 1C respectively show an electrochemical cell.

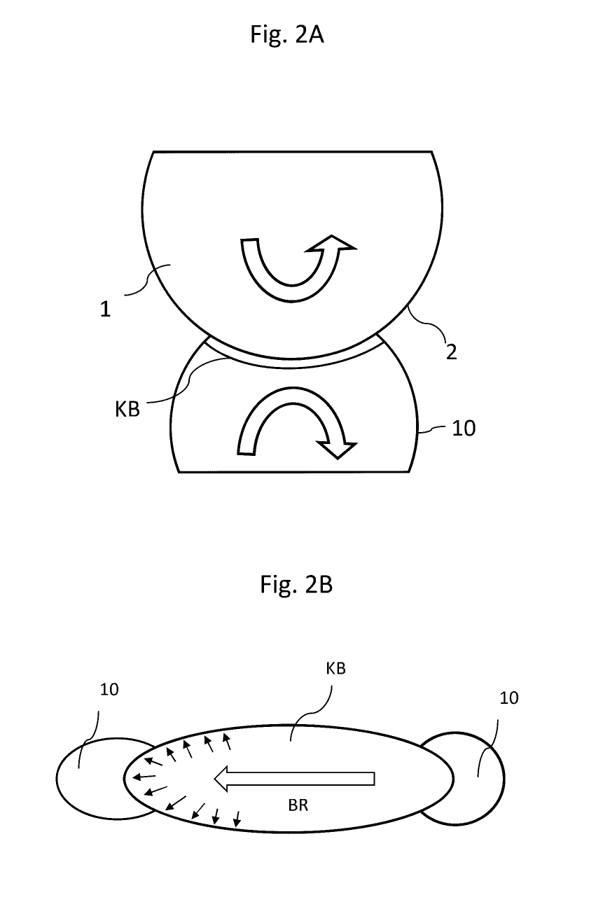

FIG. 2A schematically indicates a beading of a housing part of an electrochemical cell.

FIG. 2B schematically indicates a deformation of a housing part.

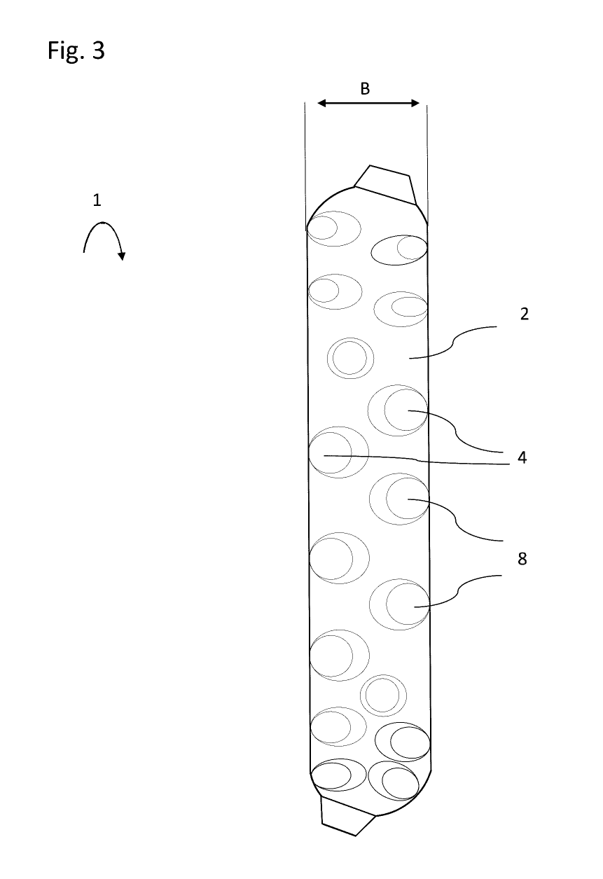

FIG. 3 schematically shows a beading wheel according to the invention.

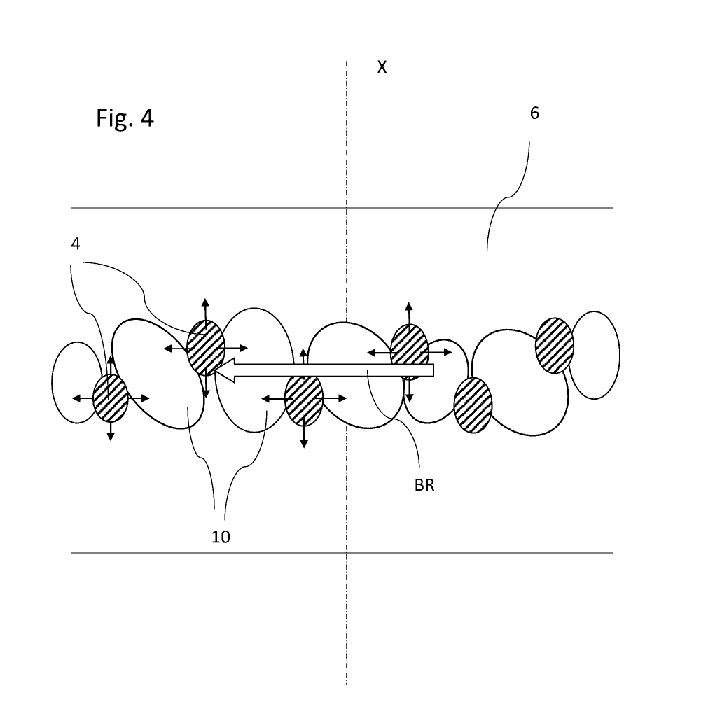

FIG. 4 indicates a deformation according to the invention of a housing part.

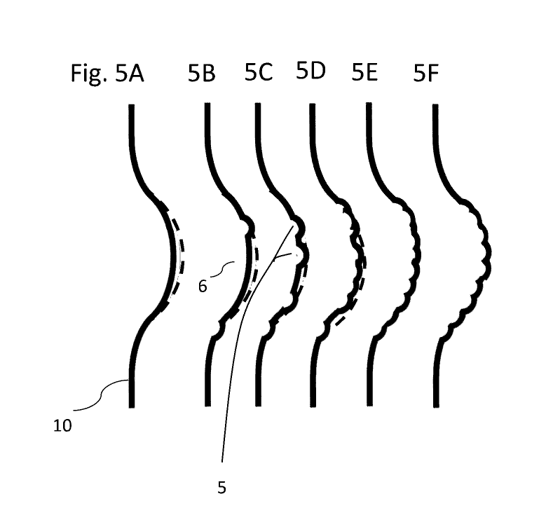

FIGS. 5A to 5F schematically indicate a beading according to the invention of a housing part.

Elements that are the same, of the same type or have the same effect are provided with the same designations in the figures. The figures and the relative sizes in relation to one another of the elements represented in the figures are not to be regarded as to scale. Rather, individual elements may be shown exaggerated in size for the sake of better representation and/or better understanding.

FIG. 1A shows a conventional electrochemical cell 100. The electrochemical cell 100 is preferably an electrolytic capacitor, for example an aluminum electrolytic capacitor. The electrochemical cell 100 has a principal axis X. Along the principal axis, the electrochemical cell has the length L. The electrochemical cell 100 also has a housing or housing part 10. Also, the electrochemical cell 100 has an electrode stack 20. The electrode stack may be a capacitor winding. The electrode stack 20 has electrode films 21. Furthermore, the electrode stack 20 or the electrochemical cell 100 expediently has an electrolyte (not explicitly represented). According to FIG. 1A, the electrochemical cell 100 has, at least in the region of the electrode stack 20, a smooth housing wall or surface without indentations. As a result, when there are sufficient impact loading or vibrational loading effects, the electrode stack 20 can for example move in relation to the housing part 10, while at the same time it is possible for the function of the electrochemical cell to be impaired.

By contrast with FIG. 1A, in FIG. 1B the housing part 10 is beaded or has a bead or indentation 6. The indentation 6 preferably runs along the entire circumference of the housing part 10. The indentation 6 may be arranged so as to run around the housing part 10. As a result, the housing part 10 can be fixed or axially braced in relation to the electrode stack 20. With the aid of the indentation 6, the electrode stack 20 can preferably be held or braced in a number of directions, for example axially and radially (as indicated by the double-headed arrows in FIG. 1B).

Without the indentation 6, the electrode stack is only held by the axial bracing between a top and a bottom (parts not explicitly identified) of the housing part 10. With the indentation 6, on the other hand, the electrode stack is held from all sides and/or in particular is axially and radially braced or fixed.

In FIG. 1C, the housing part 10 of the electrochemical cell 100 is provided with two indentations 6, which are arranged axially offset in relation to one another, whereby under certain circumstances a bracing of the electrode stack 20 in relation to the housing part 10 or other properties of the electrochemical cell 100 can be further improved.

In FIG. 2A, part of a beading tool 1 is indicated in a lateral representation, the beading tool 1 interacting with a housing part 10 of an electrochemical cell (cf. FIGS. 1A to 1C) during a conventional beading process. The beading tool 1, preferably a beading wheel, has a contact area 2. By way of the contact area 2, the beading wheel 1 interacts with the housing part 10. FIG. 2A preferably shows a side view or cross-sectional view of the components mentioned. It is indicated in FIG. 2A by the curved arrows that, during the beading shown, either the housing part 10 or the beading tool or both parts rotate(s) and/or is/are driven, once they have been brought into mechanical contact with one another. The housing part 10 is in this case deformed or squeezed in a contact region KB of the housing part 10. Accordingly, the housing part 10 is expediently produced from a deformable material, for example a metal. In the contact region KB, the beading wheel 1 interacts mechanically with the housing part 10.

In FIG. 2B, the aforementioned contact region KB is schematically represented from a different perspective along with regions of the housing part 10. The large arrow directed to the left in the contact region KB indicates a direction of movement BR of the beading tool 1 (compare FIG. 2A) on the housing part 10. The small arrows, which point from an interior of the contact region KB on the left side of the same to a periphery of the contact region KB, indicate a material displacement or plastic material deformation of the material of the housing part 10 (compare FIG. 2A).

During the beading described, the beading tool 1 presses directly onto the housing part and indirectly onto the electrode stack described above (not explicitly identified in FIG. 2A). The housing part and the electrode stack 20 are thereby deformed, preferably both irreversibly (plastically) and reversibly (elastically). After the beading or after the housing part 10 is no longer in mechanical contact with the beading tool 1 and/or exerts a force on the latter, the housing part 10 or a wall thereof springs back and a holding diameter, i.e. an inside diameter of the housing part 10, in the indentation becomes greater, for example from 22.2 mm during the beading to 22.6 mm thereafter. The elastic deformation of the electrode stack 20 is sufficient to follow this expansion of the housing part, so that the housing part 10 holds or fixes the electrode stack 20. It is disadvantageous in this case that, during this recovery or relaxation, the mechanical forces between the electrode stack 20 (see above) and the housing part 10 become smaller, so that, for example during vibrational loading or acceleration, the electrochemical cell 100 may be stable “only” up to about 30 g.

A further disadvantage is a thinning of the material of the housing part 10. During the beading described, the housing part 10 becomes thinner at the location at which it interacts with the beading tool 1 (material displacement), with the consequence that it also becomes longer (cf. length L in FIGS. 1A to 1C).

After a number of revolutions during the beading, lengthenings of typically 0.2 mm may occur. This lengthening of the housing is disadvantageous for the fixing of the electrode stack or capacitor winding in the housing part 10, since the axial holding forces subside as a result. Consequently, the vibrational load-bearing capacity in the axial direction also becomes less. A second axially offset indentation 6 may have the effect that the bracing that originates from the first indentation 6 is even loosened again.

It is now intended to describe on the basis of the following FIGS. 3, 4 and 5A to 5F the beading according to the invention of a housing part 10 for an electrochemical cell as described above, with a beading tool according to the invention, and a housing part 10 of the electrochemical cell 100 correspondingly treated with the beading tool. The aspects described above in the context of the electrochemical cell may likewise relate to the subjects of the present invention that are described below.

FIG. 3 schematically shows a representation of a contact area of a beading tool 1 according to the present invention. The beading tool 1 may be a beading wheel or a beading roller. The beading tool 1 has a contact area 2. The contact area 2 is preferably designed to interact with a workpiece, for example a housing part of an electrochemical cell (see above).

The contact area 2 may be arranged as running around the beading tool 1, for example circumferentially. The contact area 2 has a multiplicity of elevations 4. The elevations 4 are local and delimited from one another. The elevations 4 may be kept at a distance from a periphery (not explicitly identified) of the contact area 2. Furthermore, the elevations respectively have elevation areas 8. The elevation areas 8 preferably represent surfaces of the elevations perpendicularly to the direction of elevation. The elevation areas 8 preferably have an area content of between 0.1 mm² and 1 mm². Alternatively, the area content of the elevation areas 8 may be less than 0.1 mm², for example 0.01 mm², or greater than 1 mm², for example 10 mm². Moreover, the distances between adjacent elevations are preferably greater than 0.5 mm (distances not explicitly identified). One dimension of the elevations 4 is preferably less than a width B of the contact area 2. Preferably, the elevations 4 are also arranged in a randomly distributed and/or irregular manner.

FIG. 4 schematically indicates a deformation of the housing part 10 according to a beading according to the invention. The housing part 10 is not represented as a whole, but only in the form of certain regions (cf. designation 10 in FIG. 3). Also represented are the elevations 4 of the beading tool 1, which are arranged irregularly next to one another. The indentation 6 is indicated by the horizontal lines. The configuration of the elevations 4 has the effect that a deformation or displacement of the material of the housing part 10, which without the elevations takes place mainly toward the periphery of the indentation 6, that is to say in the direction of the principal axis X, is also achieved within the indentation 6 (cf. vertical and horizontal arrows on the elevations 4), so that a thinning of the material of the housing part 10 at the periphery of the indentation can be at least partially counteracted. The “splitting” effect emanating from a normal smooth beading tool can be advantageously prevented here, because the regions identified in FIG. 4 of the housing part 10 between the elevations 4 counteract the splitting or thinning of the housing part 10. The size and form of the elevations 4 make possible in this respect the formation of many small deformations, and as a result also help to restrict or prevent the aforementioned recovery of the housing part 10 after the beading. The reason for this is that a single small deformation brings about a recovery or resilient relaxation that is smaller in relation to it.

In other words, the deformation of the housing part is not achieved by a large force-exerting area or squeezing area, but by the many, small elevation areas (cf. FIG. 3). As a result, the outer dimensions of the housing part 10, in particular the length L, are influenced less, in particular increased less. Furthermore, a recovery over a large area when the beading wheel is removed is avoided (cf. below). By contrast with conventional beading, for example with a smooth bead or indentation, possibly more revolutions with the beading tool are necessary according to the invention in order to stamp the indentation together with the depressions expediently into the housing part. This process may also be referred to as a kind of “sharpening”.

FIGS. 5A to 5F indicate the treatment according to the invention of a housing part 10 of an electrochemical cell 100 as described above, in particular the beading of the housing part, for example during the production of the electrochemical cell. In each case a contour of the housing part 10 can be seen, created during the method for the beading of the housing part 10, or the providing of the housing part with a bead or indentation 6 according to the invention.

In FIGS. 5A to 5F, the electrode stack that is respectively to be fixed axially in relation to the housing part 10 by the indentation 6 (cf. FIGS. 1A to 1C) is not depicted for the sake of better overall clarity. In FIG. 5A, the housing part 10 has only been provided with a conventional indentation 6 with a smooth surface (cf. also FIGS. 1A to 1C). In a way corresponding to the form of the bead 6, an outer space of the housing part 10 must be imagined on the left side of the housing part 10, or the contour thereof, and an inner space or cavity (not explicitly identified) of the housing part 10 must be imagined on the right side. The dashed line or contour respectively indicates the position of the housing part 10 during the treatment method or during the beading. A minimum diameter of the housing part 10 or of the contour is defined by this line or contour, whereas the solid line indicates a recovery and/or a holding diameter (see above). This likewise applies to the other figures.

In FIG. 5B, a beading process according to the invention with a beading tool according to the invention (cf. FIG. 3) has been applied to the housing part 10, so that two depressions 5 have already been stamped in the cross section or region of the housing part 10 that is shown. The size and form of the depressions 5 preferably correspond substantially to the size and form of the elevations 4 of the beading tool 1 that is used.

It can be seen in FIG. 5B that, as a result, the holding diameter has already approached the minimum diameter of the housing part, i.e. the solid-line contour has moved closer to the dashed line in FIG. 5B than is the case in FIG. 5A. The holding diameter (without explicitly being represented) is preferably measured up to the opposite side (not represented) of the respective housing part 10.

FIGS. 5B to 5F preferably represent snapshots of beading according to the invention, the housing part 10 being progressively deformed—possibly by a number of revolutions of the beading wheel on the housing part 10—and thereby provided with more and more depressions 5. The surface of the indentation 6 is correspondingly increased in size in FIG. 5F—by contrast with FIG. 5A—, so that a plastic deformation of the material of the housing part 10, in particular at the periphery of the indentation 6 in the state of the housing part from FIG. 5F, can be decisively prevented.

In FIGS. 5E and 5F, the solid-line contour and the dashed-line contour are congruent for example, so that the dashed-line contour is already no longer visible. Correspondingly, here, too, the recovery of the housing part 10 is prevented (see above). Furthermore, as described above, in particular a thinning of material at the periphery of the indentation 6 can be counteracted (compare FIGS. 2A and 2B).

For example, the diameter of an electrode stack may be 22.2 mm. Once the electrode stack has been introduced into a housing part and, for the beading in a suitable device, a conventional beading wheel has been pressed against the housing part, which is for example rotating, the holding diameter (see above) may be 22.6 mm. That is to say that the holding diameter is increased in the relaxation described above by 0.4 mm. The housing part 10 has preferably or usually become longer thereby by about 0.2 mm.

After use of the beading wheel according to the invention (cf. FIG. 3), a holding diameter of 22.4 mm can preferably be measured. That is to say that the holding diameter has now increased in the relaxation only by 0.2 mm.

In order to achieve more uniform beading, the corresponding housing part may be re-worked once again with a conventional or standard beading wheel, so that smaller elevations are pressed in. With this “re-work”, the holding diameter may have been further reduced to 22.3 mm.

Because of the small linear extension of the housing part, the housing part according to the invention may also be provided with a double bead, i.e. two indentations axially offset from one another, without, as mentioned above, an axial fixing of the electrode stack being released or loosened again by the stamping in of the second indentation. According to the invention, such double beading processes or beadings allow the housing parts to be lengthened by less than 0.1 mm. As in the example mentioned above, the holding diameter here may be 22.4 mm.

Before beading according to the invention, the beading tool may also be deburred, in order to achieve better results and/or more uniform beading.

Further advantages of the proposed beading concern the possibility that, by contrast with an electrochemical cell or a capacitor that has been beaded with an upset bead, the diameter of the electrode stack or of the capacitor winding is not restricted by the treatment or beading method. As a result, the inner volume of the housing part can be used more efficiently, because no minimum bead depth has to be achieved to achieve a plastic deformation. Furthermore, by contrast with the upset bead, the mechanical stability of the electrochemical cell in the longitudinal direction for example is retained.

Moreover, the indentation may ultimately penetrate deeper into the winding because the risk of damage depends on the depth of the bead (cf. minimum diameter above) during the beading and not on the final state of the bead (cf. holding diameter above). That is to say that, with the same risk of damage, the bead according to the invention may penetrate deeper into the electrode stack. If the depth of the bead is set too small, so that for example no counter forces from the electrode stack act, the surface of the bead may become relatively smooth after a number of revolutions. If, however, the beading tool or beading wheel is set too deep, very high forces then act between the electrode stack and the beading wheel and the material will inevitably be diverted onto the grooves of the beading wheel. Then, the surface of the bead does not become smooth even after a number of revolutions. That is to say that the surface of the bead contains information concerning the forces that are exerted by the electrode stack, and consequently provides an indication of whether the depth of the bead was or is correctly set. Under some circumstances, the continual measurement of the “gleam factor” or the reflectivity of the housing part may allow the depth of the bead to be controlled such that the optimum depth of the bead is always achieved, even with varying diameters of the electrode stack.

Before the beading, an electrode stack 20 (compare FIGS. 1A to 1C) is expediently introduced into the housing part 10, so that, during the beading, the electrode stack is fixed with the housing part 10. In this case, the method step from FIG. 5A (bead 6 with smooth surface) may under certain circumstances already be carried out without the electrode stack having been introduced into the housing part 10.

It is also provided within the scope of the present application that the housing parts of the electrochemical cells are provided with a multiplicity of beads or indentations according to the invention. The beads presented may also be combined with upset beads. A number of beads have the advantage for example of better thermal coupling between the electrode stack and the housing part, it likewise being possible for the alternating current carrying capacity to be advantageously increased, in particular in combination with a heat dissipator, preferably comprising aluminum. The layer of the heat dissipator that is effective for great heat conduction preferably consists of aluminum (Al). This layer may, however, also be formed from an electrically insulating material with good heat conducting properties.

A composite material that is suitable for forming heat dissipators, preferably an aluminum adhesive strip, may for example take the form of a strip that has a backing layer of Al (Al foil) and an adhesion promoting layer applied on top. Alternatively, it is possible to provide a heat dissipator in the form of an Al strip with an adhesive layer in certain portions, for example on at least one end of the strip. An aluminum adhesive strip, for example with a total thickness of 40 to 60 micrometers, may be provided. The thickness of the adhesion promoting layer is in this case for example 10 to 50% of the total thickness of the aluminum adhesive strip.

The housing part may for example be provided with the indentation according to the invention by means of a single beading tool or beading wheel according to the invention.

Alternatively, the following sequential process steps may be provided:
beading with a beading tool with a smooth surface and without elevations according to the invention, for example until the housing part touches the electrode stack,
beading with a coarsely structured beading tool, in order to avoid the mentioned linear extension of the housing part, and
beading with a finely structured beading tool, in order to minimize the mentioned recovery of the housing part.

The housing part may also already be provided during its production with a not very pronounced bead, which makes it possible for the electrode stack still to be introduced. Then, after introduction or assembly, this bead can then also be made deeper with a beading wheel described above, so that fixing of the electrode stack can be achieved without lengthening of the housing part.

The invention is not restricted by the description on the basis of the exemplary embodiments. Rather, the invention comprises every novel feature and every combination of features, which includes in particular any combination of features in the patent claims, even if this feature or this combination itself is not explicitly specified in the patent claims or exemplary embodiments.

### LIST OF DESIGNATIONS

1 beading tool
2 contact area
4 elevation
5 depression
6 indentation
8 elevation areas
10 housing part
20 electrode stack
21 electrode films
100 electrochemical cell
L length
B width
KB contact region
BR direction of movement
X principal axis

1. A beading tool for the beading of a workpiece, the beading tool having a contact area, which is designed to interact with the workpiece, the contact area having a multiplicity of local elevations that are delimited from one another, the distance of a first elevation from an elevation that is arranged closest to it differing from the distance of a second elevation from an elevation that is arranged closest to it.

2. The beading tool according to claim 1, one dimension of the elevations being less than a width of the contact area.

3. The beading tool according to claim 1, the elevations having elevation areas with an area content of between 0.1 mm² and 1 mm².

4. The beading tool according to claim 1 the distance between adjacent elevations being greater than 0.5 mm.

5. The beading tool according to claim 1, the elevations being arranged in a randomly distributed and/or irregular manner.

6. The beading tool according to claim 1, which is a beading wheel or a beading roller.

7. The beading tool according to claim 1, the beading tool being designed to interact with the workpiece unilaterally from the outside.

8. An electrochemical cell comprising a housing part and an electrode stack arranged in the housing part the housing part defining a cavity and having at least one indentation, a multiplicity of local depressions being formed in the indentation, and the at least one indentation fixing the electrode stack in relation to the housing part.

9. The electrochemical cell according to claim 8, the indentation extending over the entire circumference of the housing part.

10. The electrochemical cell according to claim 8, the indentation being a first indentation, and the housing part having a second indentation, which is arranged axially offset from the first indentation.

11. The electrochemical cell according to claim 8, which is formed according to an electrolytic capacitor, the electrode stack being a capacitor winding, which comprises electrode films and an electrolyte that is in contact with the electrode films.

12. A method for producing an electrochemical cell with the following steps:
providing a housing part and a beading tool,
providing an electrode stack and introducing the electrode stack into the housing part,
providing the housing part with a bead by means of the beading tool in such a way that a multiplicity of local depressions that are delimited from one another and are inwardly directed are formed in the bead, the electrode stack being fixed in the housing part by being provided with the bead.

13. The method according to claim 12, wherein, when providing the housing part with the bead in a first working step by means of a coarse beading tool, a contour of the bead and/or of the depressions is stamped into the housing part and, in a subsequent working step by means of a fine beading tool, the depressions are defined.

14. The method according to claim 13, wherein, after introducing the electrode stack into the housing part, the housing part is first deformed until the housing part touches the electrode stack, and wherein the housing part is subsequently provided with the bead.

15. The method according to claim 12, wherein, when producing the bead, the beading tool acts on the housing part unilaterally from the outside.
